(19) United States
(12) Patent Application Publication
(10) Pub. No.: US 2018/0063765 A1
(43) Pub. Date: Mar. 1, 2018

(54) SCHEDULING CONNECTED MODE MEASUREMENTS FOR MOBILITY OPERATION

(71) Applicant: QUALCOMM Incorporated, San Diego, CA (US)

(72) Inventors: Hargovind Prasad Bansal, Hyderabad (IN); Pankaj Gupta, Hyderabad (IN); Praveen Nagaraja Kona, Hyderabad (IN)

(21) Appl. No.: 15/244,982

(22) Filed: Aug. 23, 2016

(51) Int. Cl. H04W 36/32; H04W 24/02

(52) U.S. Cl. CPC H04W 36/32; H04W 24/02

(57) ABSTRACT

Methods, systems, and devices for wireless communication are described. A mobile device may receive a measurement configuration relating to signal measurements (e.g., neighboring cells, carriers, frequencies, etc.) which are performed by the mobile device in support of mobility and other behaviors. The mobile device may prioritize the signal measurements based on historic or crowd-sourced information. When a measurement procedure is unsuccessful, the mobile device may exclude a corresponding object from its measurement configuration in order to increase the likelihood of performing successful measurements involving other such objects. Objects from the measurement configuration may be excluded temporarily or permanently. Measurement objects may be prioritized based on past successful measurements, a location of the wireless device, and/or depending on whether they were previously excluded. The mobile device may report successful measurements to the base station.

### BACKGROUND

The following relates generally to wireless communication and more specifically to scheduling connected mode measurements for mobility operations.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems, (e.g., a Long Term Evolution (LTE) system). A wireless multiple-access communications system may include a number of base stations, each simultaneously supporting communication for multiple communication devices, which may be otherwise known as user equipment (UE).

Within a wireless communications system, a base station may send a measurement request to direct a UE to search and measure a quality of communication channels or cells of the wireless communications systems. The measurement request may direct the UE to measure the quality of a communication link between the UE and a serving cell or between the UE and other potential links. However, in some cases, UE may be unable to measure a requested cell which can lead to inefficient resource utilization.

### SUMMARY

A user equipment (UE) may receive a list of measurement objects from a base station or other network entity. This list of measurement objects may correspond to measurement procedures in which signals in a wireless network are measured by a UE to detect one or more candidate cells. The UE may attempt to perform measurements corresponding to the objects in the list in an order of its measurement configuration, or the UE may prioritize the objects for measurement based on historic or crowd-sourced information. For example, if measurements of one of the objects in the list is unsuccessful, the UE may exclude the object from the list of objects for some predetermined amount of time. This may allow the UE to avoid continuous unsuccessful attempts to measure an object. This may also increase the likelihood of performing successful measurements on other objects in the list.

By way of example, a list measurement objects may include objects associated with the UE measuring a quality (e.g., signal strength) of communication channels or cells associated with the wireless communications systems. In some cases, a UE may receive a measurement request, from a base station that directs the UE to measure a quality of a communication link between the UE and a serving cell. In other cases, the received measurement request may direct the UE to measure a quality between the UE and other potential links, including other channels (e.g., frequencies) within the serving cell, other cells, and/or other radio access technologies (RATs).

The UE may increase a likelihood of performing a successful measurement procedure on one or several measurement objects by determining whether an attempted measurement procedure is successful, and by avoiding attempted measurements that are unlikely to be successful or that are known to be unsuccessful. The UE may temporarily or permanently exclude a measurement object from a list and proceed to measure other measurement objects in the list. Additionally, in some cases, after a predetermined duration of the UE performing a measurement procedure on the remaining measurement objects in the list, the UE may attempt to re-measure the previously failed measurement object(s)—i.e., the UE may return the excluded measurement object to the list.

A method performed by a user equipment (UE) in a wireless communication system is described. The method may include receiving, from a serving base station, a measurement configuration comprising a list of measurement objects associated with measurements performed by the UE on signals received from cells in the wireless communication system; performing a first measurement procedure comprising measuring a signal in the wireless communication system to detect one or more candidate cells associated with a first measurement object, wherein the first measurement procedure is performed a predetermined number of times; suspending the first measurement object from a subsequent measurement procedure when the predetermined number of times that the first measurement procedure is performed without detecting the one or more candidate cells associated with the first measurement object exceeds a threshold; performing a second measurement procedure comprising measuring a signal in the wireless communication system to detect one or more candidate cells associated with a second measurement object; and transmitting a measurement report to the serving base station, wherein the measurement report is based at least in part on a measurement obtained from the second measurement procedure.

An apparatus for wireless communication is described. The apparatus may include means for receiving, from a serving base station, a measurement configuration comprising a list of measurement objects associated with measurements performed by a UE on signals received from cells in a wireless communication system; means for performing a first measurement procedure comprising measuring a signal in the wireless communication system to detect one or more candidate cells associated with a first measurement object, wherein the first measurement procedure is performed a predetermined number of times; means for suspending the first measurement object from a subsequent measurement procedure when the predetermined number of times that the first measurement procedure is performed without detecting the one or more candidate cells associated with the first measurement object exceeds a threshold; means for performing a second measurement procedure comprising measuring a signal in the wireless communication system to detect one or more candidate cells associated with a second measurement object; and means for transmitting a measurement report to the serving base station, wherein the measurement report is based at least in part on a measurement obtained from the second measurement procedure.

A further apparatus is described. The apparatus may be a mobile device or an aspect of a mobile device. The apparatus may include a processor, memory in electronic communication with the processor, and instructions stored in the memory. The instructions may be operable to cause the processor to receive, from a serving base station, a measurement configuration comprising a list of measurement objects associated with measurements performed by the UE on signals received from cells in the wireless communication system; perform a first measurement procedure comprising measuring a signal in the wireless communication system to detect one or more candidate cells associated with a first measurement object, wherein the first measurement procedure is performed a predetermined number of times; suspend the first measurement object from a subsequent measurement procedure when the predetermined number of times that the first measurement procedure is performed without detecting the one or more candidate cells associated with the first measurement object exceeds a threshold; perform a second measurement procedure comprising measuring a signal in the wireless communication system to detect one or more candidate cells associated with a second measurement object; and transmit a measurement report to the serving base station, wherein the measurement report is based at least in part on a measurement obtained from the second measurement procedure.

A non-transitory computer readable medium for wireless communication is described. The non-transitory computer-readable medium may include instructions to cause a processor to receive, from a serving base station, a measurement configuration comprising a list of measurement objects associated with measurements performed by the UE on signals received from cells in the wireless communication system; perform a first measurement procedure comprising measuring a signal in the wireless communication system to detect one or more candidate cells associated with a first measurement object, wherein the first measurement procedure is performed a predetermined number of times; suspend the first measurement object from a subsequent measurement procedure when the predetermined number of times that the first measurement procedure is performed without detecting the one or more candidate cells associated with the first measurement object exceeds a threshold; perform a second measurement procedure comprising measuring a signal in the wireless communication system to detect one or more candidate cells associated with a second measurement object; and transmit a measurement report to the serving base station, wherein the measurement report is based at least in part on a measurement obtained from the second measurement procedure.

Some examples of the methods, apparatuses, or non-transitory computer-readable media described herein may further include processes, features, means, or instructions for suspending measurements of the one or more candidate cells associated with the first measurement object for a predetermined duration. Some examples of the methods, apparatuses, or non-transitory computer-readable media described herein may further include processes, features, means, or instructions for performing the first measurement procedure on the first measurement object an additional number of times after the predetermined duration.

Some examples of the methods, apparatuses, or non-transitory computer-readable media described herein may further include processes, features, means, or instructions for storing an indication that the one or more candidate cells associated with the second measurement object was measured based at least in part on obtaining the measurement from the second measurement procedure.

Some examples of the methods, apparatuses, or non-transitory computer-readable media described herein may further include processes, features, means, or instructions for prioritizing the second measurement object for a subsequent measurement procedure over at least one other measurement object from the list of measurement objects based at least in part on the indication. Some examples of the methods, apparatuses, or non-transitory computer-readable media described herein may further include processes, features, means, or instructions for retrieving a list of previously measured measurement objects associated with measurements performed by the UE on signals received from the cells in the wireless communication system; determining that at least one of the previously measured cells is associated with a measurement object in the list of measurement objects received from the serving base station; and prioritizing the measurement object associated with the at least one previously measured cell over other measurement objects for a measurement procedure.

Some examples of the methods, apparatuses, or non-transitory computer-readable media described herein may further include processes, features, means, or instructions for determining a location of the UE, and identifying the at least one previously measured cell from the list of previously measured cells based at least in part on the location of the UE.

In some examples of the methods, apparatuses, or non-transitory computer-readable media described herein, the second measurement procedure is performed during the predetermined duration. In some examples of the methods, apparatuses, or non-transitory computer-readable media described herein, the at least one measurement object in the list of measurement objects is prioritized based at least in part on an association with the at least one previously measured cell and the location of the UE. In some examples of the methods, apparatuses, or non-transitory computer-readable media described herein, the location of the UE is determined based at least in part on global positioning system (GPS) coordinates of the UE. In some examples of the methods, apparatuses, or non-transitory computer-readable media described herein, the at least one previously measured cell is identified based at least in part on global positioning system (GPS) coordinates of the UE when the at least one previously measured cell was measured. In some examples of the methods, apparatuses, or non-transitory computer-readable media described herein, the threshold is associated with a predetermined number of repetitions or a time duration, or both. In some examples of the methods, apparatuses, or non-transitory computer-readable media described herein, the measurement objects comprise one or more communication channels associated with a serving cell, a neighbor cell, a frequency, a radio access technology (RAT), or any combination thereof.

### BRIEF DESCRIPTION OF THE DRAWINGS

FIG. 1 illustrates an example of a system for wireless communication that supports scheduling connected mode measurements for mobility operations in accordance with aspects of the present disclosure.

FIG. 2 illustrates an example of a wireless communication system for scheduling connected mode measurements for mobility operations, in accordance with various aspects of the present disclosure.

FIG. 3 illustrates an example of a process flow that supports scheduling connected mode measurements for mobility operations in accordance with aspects of the present disclosure.

FIGS. 4 through 6 show block diagrams of a device that supports scheduling connected mode measurements for mobility operations in accordance with aspects of the present disclosure.

FIG. 7 illustrates a block diagram of a system including a UE that supports scheduling connected mode measurements for mobility operations in accordance with aspects of the present disclosure.

FIGS. 8 through 10 illustrate methods for scheduling connected mode measurements for mobility operations in accordance with aspects of the present disclosure.

### DETAILED DESCRIPTION

A wireless device, such as a user equipment (UE), may receive a list of measurement objects from a base station or another network entity. The measurement objects may be associated with the UE measuring a feature of a communication channel or cell associated with the network device. For example, a UE may receive a measurement request in the form of a list of measurement objects that directs the UE to measure a quality of a communication link between the UE and a serving cell (e.g., serving base station). In some cases, the measurement objects may relate to a quality between the UE and other potential links, including other channels (e.g., frequencies) within the serving cell, other cells, and/or other radio access technologies (RATs).

Instead of attempting to measure the objects in the list in the order of its measurement configuration, the UE may prioritize the objects for measurement based on historic or crowd-sourced information, which may increase the likelihood that the UE will successfully measure and report on objects in the list. For example, if the UE attempts to measure one object (e.g., a particular cell), and if the measurements fails (e.g., due to poor signal conditions), the UE may continually attempt to measure that object until the network directs it not to unless the UE takes some affirmative action to avoid the unsuccessful measurement. The UE may thus be fixed on one measurement object and none of the other objects may be measured if the UE does not employ some prioritization or efforts to exclude unsuccessful measurement objections.

To avoid these issues, when measurements of one of the objects is unsuccessful, the UE may exclude the object from the list of objects to be measured in order to increase the likelihood of performing successful measurements on other objects in the list. Objects may be excluded temporarily or permanently. Additionally or alternatively, measurement objects may be prioritized based on past successful measurements, a location of the wireless device, or depending on whether they were previously excluded. Successful measurements may be used to generate reports for transmission to the base station. For instance, the UE may re-order measurement objects in a measurement object list. The UE may store in a database an indication (e.g., successful/unsuccessful) of each measurement objects previously measured. In some cases, the UE may receive a list of measurement objects from a network device and prioritize the list by comparing the measurement objects in the list to the previously measured measurement objects based on the indication.

Aspects of the disclosure introduced above are initially described in the context of a wireless communication system. Specific examples of mobile device operation associated with scheduling connected mode measurements for mobility operations are then provided. Aspects of the disclosure are further illustrated by and described with reference to device diagrams, system diagrams, and flowcharts that relate to scheduling connected mode measurements for mobility operations.

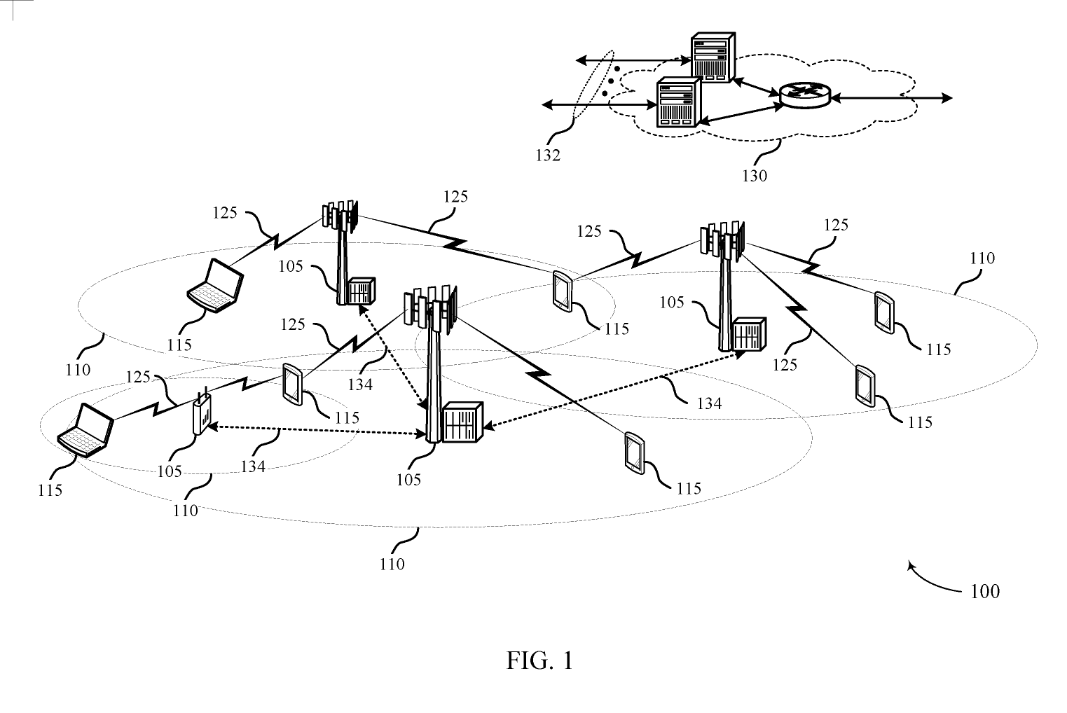

FIG. 1 illustrates an example of a wireless communications system 100 in accordance with various aspects of the present disclosure. The wireless communications system 100 includes base stations 105, UEs 115, and a core network 130. In some examples, the wireless communications system 100 may be a LTE (or LTE-Advanced) network. The core network 130 may provide user authentication, access authorization, tracking, Internet Protocol (IP) connectivity, and other access, routing, or mobility functions. The base stations 105 may interface with the core network 130 through backhaul links 134 (e.g., S1, etc.) and may perform radio configuration and scheduling for communication with the UEs 115, or may operate under the control of a base station controller (not shown). In various examples, the base stations 105 may communicate, either directly or indirectly (e.g., through core network 130), with each other over backhaul links 132 (e.g., X1, etc.), which may be wired or wireless communication links

Base stations 105 may wirelessly communicate with UEs 115 via one or more base station antennas using communication links 125. Each base station 105 may provide communication coverage for a respective geographic coverage area 110. Communication links 125 shown in wireless communications system 100 may include UL transmissions from a UE 115 to a base station 105, or DL transmissions, from a base station 105 to a UE 115. The downlink (DL) transmissions may be referred to as forward link transmissions, while the uplink (UL) transmissions may, additionally or alternatively, be called reverse link transmissions.

UEs 115 may be dispersed throughout the wireless communications system 100, and each UE 115 may be stationary or mobile. A UE 115 may also be referred to as a mobile station, a subscriber station, a remote unit, a wireless device, an access terminal (AT), a handset, a user agent, a client, or like terminology. A UE 115 may also be a cellular phone, a wireless modem, a handheld device, a personal computer, a tablet, a personal electronic device, a machine-type-communication (MTC) device, or the like.

Base stations 105 may communicate with the core network 130 and with one another. For example, base stations 105 may interface with the core network 130 through backhaul links 132 (e.g., S1, etc.). Base stations 105 may communicate with one another over backhaul links 134 (e.g., X2, etc.) either directly or indirectly (e.g., through core network 130). Base stations 105 may perform radio configuration and scheduling for communication with UEs 115, or may operate under the control of a base station controller (not shown). In some examples, base stations 105 may be macro cells, small cells, hot spots, or the like. Base stations 105 may also be referred to as eNodeBs (eNBs) 105. To facilitate mobility by a UE 115 between base stations 105, the UE 115 may perform measurement procedures on various aspects of communication links, frequencies, and the like used by different base stations, according to a measurement configuration and as described below.

In some examples, each communication link 125 may include one or more carriers, where each carrier may be a signal made up of multiple sub-carriers (e.g., waveform signals of different frequencies) modulated according to the various radio technologies described above. Each modulated signal may be transmitted on a different sub-carrier and may carry control information (e.g., reference signals, control channels, etc.), overhead information, user data, etc. The communication links 125 may transmit bidirectional communications using a frequency domain duplexing (FDD) operation (e.g., using paired spectrum resources) or a time domain duplexing (TDD) operation (e.g., using unpaired spectrum resources). Frame structures for FDD operation (e.g., frame structure type 1) and TDD operation (e.g., frame structure type 2) may be defined. To facilitate communication using the channels of communication links 125, a UE 115 may perform measurement procedures on various aspects of communication links 125, according to a measurement configuration.

By way of example, a UE 115 may be requested to measure characteristics of a reference signal (RS) for neighboring cells. An RS may be known to the receiver and inserted into a transmitted signal in order to facilitate channel estimation for coherent demodulation and measurements. In the LTE downlink, for example, Cell-specific RSs may be provided that are available to all UEs in a cell; UE-specific RSs may be embedded in the data for specific UEs, and Multimedia Broadcast Single Frequency Network (MBSFN)-specific RSs may be provided in case of MBSFN operation. These RSs may occupy specified Resource Elements (REs) within an Orthogonal Frequency Division Multiplexed (OFDM) symbol. In the LTE uplink, Demodulation RSs (DM-RS) and Sounding RSs (SRS) may be provided for channel estimation for demodulation and channel sounding respectively.

A UE 115 may measure reference signal received power (RSRP) or reference signal received quality (RSRQ), or both, of a neighboring cell as directed by a measurement configuration. RSRP is an LTE measurement which provides a cell-specific signal strength metric. This measurement may be used to rank different LTE cells according to their signal strength as an input for handover and cell reselection decisions. The RSRP of a cell is defined as the linear average over the power contributions (in Watts) of the Resource Elements (REs) which carry cell-specific RS within the considered measurement bandwidth.

The RSs transmitted on the first eNodeB antenna port may be used for RSRP determination, but the RS on the second antenna port can also be used if the UE can determine that they are being transmitted. If the UE is equipped with multiple antennas, the reported RSRP value is not permitted to be lower than the RSRP computed on the individual branches.

RSRQ is an LTE measurement which provides a cell-specific signal quality metric. As with RSRP, this measurement may be used to rank different LTE cells according to their signal quality as an input for handover and cell reselection decisions, for example in scenarios for which RSRP measurements do not provide sufficient information to perform reliable mobility decisions. The RSRQ may be defined as the ratio N×RSRP/(LTE carrier RSSI), where N is the number of Resource Blocks (RBs) of the LTE carrier Received Signal Strength Indicator (RSSI) measurement bandwidth. While RSRP may be an indicator of the wanted signal strength, RSRQ may also takes the interference level into account due to the inclusion of RSSI. RSRQ therefore enables the combined effect of signal strength and interference to be reported in an efficient way. If the UE is equipped with multiple antennas, the reported RSRQ value is not permitted to be lower than the RSRQ computed on the individual branches.

RSSI may be a measurement defined as the total received wideband power observed by a UE from all sources, including co-channel serving and non-serving cells, adjacent channel interference and thermal noise within the measurement bandwidth. RSSI may or may not be reported as an independent measurement, but may be an input to the derivation of RSRQ.

In some examples, a UE 115 may also be asked to measure received signal code power (RSCP). RSRP may be a measurement used for mobility to base station 105 employing a radio access technology (RAT), such a UMTS. RSCP may be the received power on the Primary Common Pilot Channel (P-CPICH for UMTS FDD), or the Primary Common Control Physical Channel (for UMTS TDD) after de-spreading.

Additionally or alternatively, a UE 115 may be asked to measure and report on channel state information (CSI). For example, a base station 105 may gather channel condition information from a UE 115 in order to efficiently configure and schedule the channel. This information may be sent from the UE 115 in the form of a channel state report. A channel state report may contain an rank indictor (RI) requesting a number of layers to be used for DL transmissions (e.g., based on the antenna ports of the UE 115), a precoding matrix indicator (PMI) indicating a preference for which precoder matrix should be used (based on the number of layers), and a channel quality indicator (CQI) representing the highest MCS that may be used.

CQI may be calculated by a UE 115 after receiving predetermined pilot symbols (or RSs) such as cell-specific reference signals (CRS) or CSI-RS. CQI may be used to indicate a suitable data rate (e.g., a Modulation and Coding Scheme (MCS) value) for downlink transmissions, based on a measurement of the received downlink Signal to Interference plus Noise Ratio (SINR) and knowledge of the UE's 115 receiver characteristics.

RI and PMI may be excluded if the UE 115 does not support spatial multiplexing (or is not in support spatial mode). The types of information included in the report determines a reporting type. Channel state reports may be periodic or aperiodic. That is, a base station 105 may configure a UE 115 to send periodic reports at regular intervals, and may also request additional reports as needed. A periodic report may include wideband reports indicating the channel quality across an entire cell bandwidth, UE selected reports indicating a subset of the best subbands, or configured reports in which the subbands reported are selected by the base station 105.

A base station 105 and a UE 115 may communicate using more than one carrier. Each aggregated carrier is referred to as a component carrier (CC). Each component can have a bandwidth of, e.g., 1.4, 3, 5, 10, 15 or 20 MHz. In some cases, the number of CCs can be limited to, e.g., a maximum of five 20 MHz carriers, giving maximum aggregated bandwidth is 100 MHz. In frequency division duplexing (FDD), the number of aggregated carriers can be different in DL and UL. The number of UL component carriers may be equal to or lower than the number of DL component carriers. The individual component carriers can also be of different bandwidths. For TDD, the number of CCs as well as the bandwidths of each CC can normally be the same for DL and UL. Component carriers may be arranged in a number of ways. For example, a CA configuration may be based on contiguous component carriers within the same operating frequency band, i.e., called intra-band contiguous CA. Non-contiguous allocations can also be used, where the component carriers may be either be intra-band, or inter-band. To facilitate communication using CA, a UE 115 may perform measurement procedures on various CCs of a CA configuration according to a measurement configuration, and as described below.

Wireless communications system 100 may utilize enhanced component carriers (eCCs). An eCC may be characterized by one or more features including: wider bandwidth, shorter symbol duration, shorter transmission time interval (TTIs), and modified control channel configuration. In some cases, an eCC may be associated with a carrier aggregation configuration or a dual connectivity configuration (e.g., when multiple serving cells have a suboptimal or non-ideal backhaul link). An eCC may also be configured for use in unlicensed spectrum or shared spectrum (where more than one operator is allowed to use the spectrum). An eCC characterized by wide bandwidth may include one or more segments that may be utilized by UEs 115 that are not capable of monitoring the whole bandwidth or prefer to use a limited bandwidth (e.g., to conserve power).

The number of objects that a UE 115 is requested to measure may depend on the number of CCs or eCCs system 100, and the various UEs 115 are capable of supporting. In an enhanced CA configuration (eCA), numerous CCs (e.g., 10, 32, or more CCs) may be configured for some UEs 115, and the UEs 115 may requested to make measurements on the CCs. UEs 115 may be configured to measure the various characteristics of different CCs, including characteristics of RSs described above.

In some cases, a base station 105 may provide a UE 115 with a measurement reporting configuration identifying objects to be measured. The measurement configuration may be provided as part of an radio resource control (RRC) configuration. The RRC protocol handles the Layer 3 control plane signaling by which the radio access network, which includes base stations 105, controls the UE 115 behavior. The RRC protocol supports the transfer of both common and dedicated Non-Access Stratum information. It may cover a number of functional areas including System Information (SI) broadcasting, connection control including handover within LTE, network-controlled inter-Radio Access Technology (RAT) mobility and measurement configuration and reporting.

In some examples, a measurement reporting configuration may be sent in an RRC connection setup message during a random access procedure. For example, after a UE 115 acquires certain SI, it may transmit a random access channel (RACH) preamble to a base station 105. This may be known as RACH message 1. For example, the RACH preamble may be randomly selected from a set of 64 predetermined sequences. This may enable the base station 105 to distinguish between multiple UEs 115 trying to access the system simultaneously. The base station 105 may respond with a random access response (RAR), or RACH message 2, that provides an UL resource grant, a timing advance and a temporary cell radio network temporary identity (C-RNTI). The UE 115 may then transmit an RRC connection request, or RACH message 3, along with a temporary mobile subscriber identity (TMSI) (if the UE 115 has previously been connected to the same wireless network) or a random identifier. The RRC connection request may also indicate the reason the UE 115 is connecting to the network (e.g., emergency, signaling, data exchange, etc.).

The base station 105 may respond to the connection request with a contention resolution message, or RACH message 4, addressed to the UE 115, which may provide a new C-RNTI. If the UE 115 receives a contention resolution message with the correct identification, it may proceed with RRC setup. The RACH message 4, or RRC connection setup message, may include the measurement reporting configuration. The measurement reporting configuration may include an information element, which may be a parameter contained within the RRC signaling message. The information element may, for example, include a list of measurement objects.

The measurement reporting configuration (e.g., the list of measurement objects) may include parameters related to which neighbor cells and frequencies the UE 115 should measure, criteria for sending measurement reports, intervals for transmission of measurement reports (i.e., measurement gaps), and other related information. In some cases, measurement reports may be triggered by events related to the channel conditions of the serving cells or the neighbor cells.

For example, in an LTE system a first report (A1) may be triggered when the serving cell becomes better than a threshold; a second report (A2) when the serving cell becomes worse than a threshold; a third report (A3) when a neighbor cell becomes better than the primary serving cell by an offset value; a fourth report (A4) when a neighbor cell becomes better than a threshold; a fifth report (A5) when the primary serving cell becomes worse than a threshold and a neighbor cell is simultaneously better than another (e.g., higher) threshold; a sixth report (A6) when a neighbor cell becomes better than a secondary serving cell by an offset value; a seventh report (B1) when a neighbor using a different RAT becomes better than a threshold; and an eighth report (B2) when a primary serving cell becomes worse than a threshold and the inter-RAT neighbor becomes better than another threshold. In some cases, the UE 115 may wait for a timer interval known as time-to-trigger (TTT) to verify that the trigger condition persists before sending the report. Other reports may be sent periodically instead of being based on a trigger condition (e.g., every two seconds a UE 115 may transmit an indication of a transport block error rate). UEs 115 may send reports as they are triggered using information gathered from successful measurement procedures on measurement objects in the list.

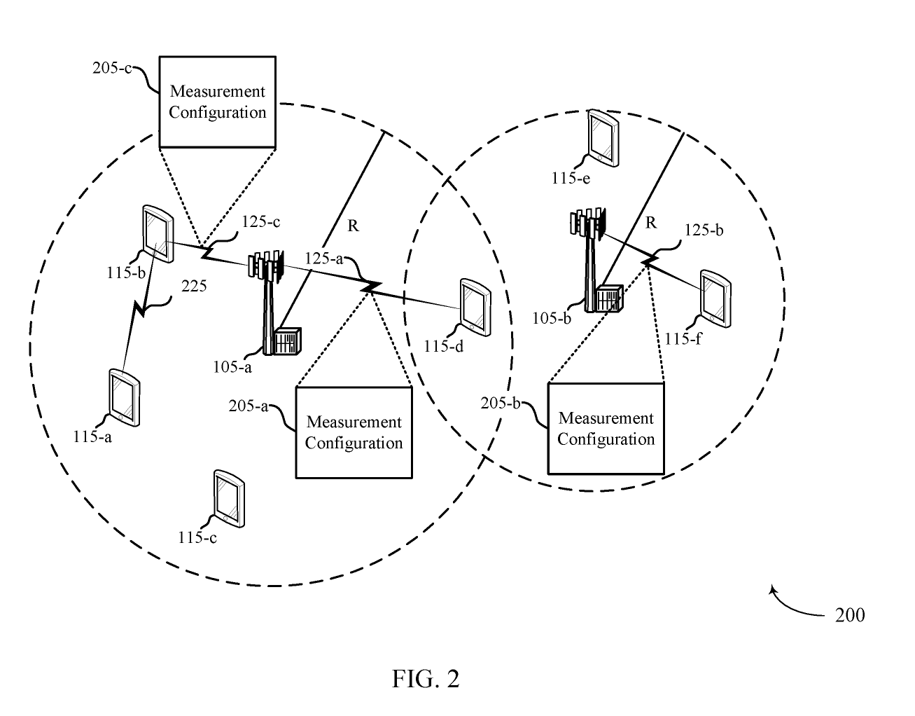

FIG. 2 illustrates an example of a wireless communication system 200 for scheduling connected mode measurements for mobility operations, in accordance with various aspects of the present disclosure. The wireless communication system 200 may include a first set of wireless communication devices (e.g., a first UE 115-a, a second UE 115-b, a third UE 115-c, a fourth UE 115-d), which may be associated with a first base station 105-a. The wireless communication system 200 may also include a second set of wireless communication devices (e.g., a fifth UE 115-e, a sixth UE 115-f), which may be associated with a second base station 105-b. The first UE 115-a, the second UE 115-b, the third UE 115-c, the fourth UE 115-d, the fifth UE 115-e, the sixth UE 115-f, the first base station 105-a, and the second base station 105-b may be examples of UE 115 and base station 105 described with reference to FIG. 1.

The first base station 105-a may transmit a first measurement configuration 205-a to UEs, including UE 115-d via communication link 125-a, within a first geographical coverage area associated with the first base station 105-a. In some cases, the first measurement configuration 205-a may be associated with a list of measurement objects. In some cases, the first base station 105-a may be a serving base station for the UEs. A second base station 105-a may transmit a second measurement configuration 205-b to UEs, including UE 115-f via communication link 125-b, within a second geographical coverage area associated with the second base station 105-b. For example, UEs 115-a through 115-d may receive a measurement configuration 205 from the first base station 105-a, and UEs 115-d through 115-f may receive a measurement configuration 205 from the second base station. In some cases, a geographical coverage area may have a predetermined radius (e.g., R).

The measurement configuration 205 may be sent using dedicated signaling. For instance, the measurement configuration 205 may be an information element in a RRC message, such as an RRC connection setup message sent during a random access procedure. Or the measurement configuration 205 may be an information element of another RRC configuration message. Or the measurement configuration 205 may be communicated using other unicast or broadcast messaging.

A UE (e.g., UE 115-d) may be within an overlap of two geographical coverage area (e.g., first geographical coverage area associated with base station 105-a and second geographical coverage area associated with base station 105-b). As a result, in some cases, the UE (e.g., UE 115-d) within the overlapped geographical coverage area may receive two measurement configuration associated with the base stations. The UEs (e.g., UE 115-d) may determine a location based at least in part on global positioning system (GPS) coordinates of the UE. UE 115-d may retrieve a previously measured measurement configuration from a database and identify at least one measurement object from a list of previously measured measurement objects associated with the measurement configuration based at least in part on the location of the UE. In some cases, UEs (e.g., UE 115-d) may retrieve a list of previously measured measurement objects associated with measurements performed by the UE (i.e., UE 115-d) on signals received from the cells, i.e., the first base station 105-a or the second base station 105-b from a database. In further cases, UEs may determine that at least one of the previously measured cells is associated with a measurement object in the list of measurement objects of a measurement configuration received from the first base station 105-a or the second base station 105-b. Alternatively, UEs may identify at least one previously measured cell from the list of previously measured cells based at least in part on the location of the UE.

In some cases, the at least one measurement object in the list of measurement objects of a measurement configuration is prioritized based at least in part on an association with the at least one previously measured cell and the location of the UE.

Additionally or alternatively, after identifying the at least one measurement object, UE 115-d may prioritize the measurement object based at least in part on the location of the UE. In some cases, UE 115-d may prioritize measurement objects in the list that are common to both base station (i.e., base station 105-a and base station 105-b). In some cases, UE 115-d may exclude or suspend a list of measurement objects associated with a base station based at least in part on a signal quality between the UE 115-d and the base station (i.e., base station 105-a and base station 105-b). In other cases, UE 115-d may suspend or exclude a list of measurement objects associated with a base station based at least in part on distance between UE 115-d and base station 105-a and base station 105-b. In some cases, UE 115-d may suspend a first measurement object from a subsequent measurement procedure when a predetermined number of times that the first measurement procedure is performed without detecting the one or more candidate cells associated with the first measurement object exceeds a threshold. In some cases, UEs may perform a first measurement procedure comprising measuring a signal in the wireless communication system to detect one or more candidate cells associated with a first measurement configuration a predetermined number of times. The UEs may, in some cases, suspend the first measurement configuration from a list of measurement objects associated with the measurement configuration when the predetermined number of times that the first measurement procedure is performed without detecting the one or more candidate cells associated with the first measurement configuration exceeds a threshold.

One or more UEs with a same geographical coverage area may share information about successful measurements with other UEs within the geographical coverage area. By way of example, wireless communication link 225 may be established between UEs 115 in a configuration known as D2D communications. One or more of a group of UEs 115 utilizing D2D communications may be within the geographic coverage area 110 of a cell. Other UEs 115 in such a group may be outside the geographic coverage area 110 of a cell, or otherwise unable to receive transmissions from a base station 105. In some cases, groups of UEs 115 communicating via D2D communications may utilize a one-to-many (1:M) system in which each UE 115 transmits to every other UE 115 in the group. In some cases, a base station 105 facilitates the scheduling of resources for D2D communications. In other cases, D2D communications are carried out independent of a base station 105.

Using D2D communication, UE 115-a may transmit information about success measurements (e.g., a location of successful measurements at a particular location) with UE 115-b via wireless communication link 225. In some cases, the UEs 115 may share information including indication of successful and/or unsuccessful measurements associated with measurement objects in a measurement configuration 205.

In some cases, UE 115-b may receive a list of measurement objects associated with a measurement configuration from base station 105-a via communication link 125-c. UE 115-b may retrieve a list of previously measured measurement objects associated with a measurement configuration from a database and determine that at least one measurement object from the list of previously measured measurement objects is common to a measurement object in the list of measurement objects associated with the measurement configuration received from the base station. UE 115-b may then prioritize the at least one measurement object from the list of previously measured measurement objects over other measurement objects for a measurement procedure. In some cases, UE 115-b may additionally or alternatively, prioritize the list of measurement objects based at least in part on the shared measurement report received from UE 115-a. Base station 105-a may, in some examples, provide information from a database related to past successful measurements.

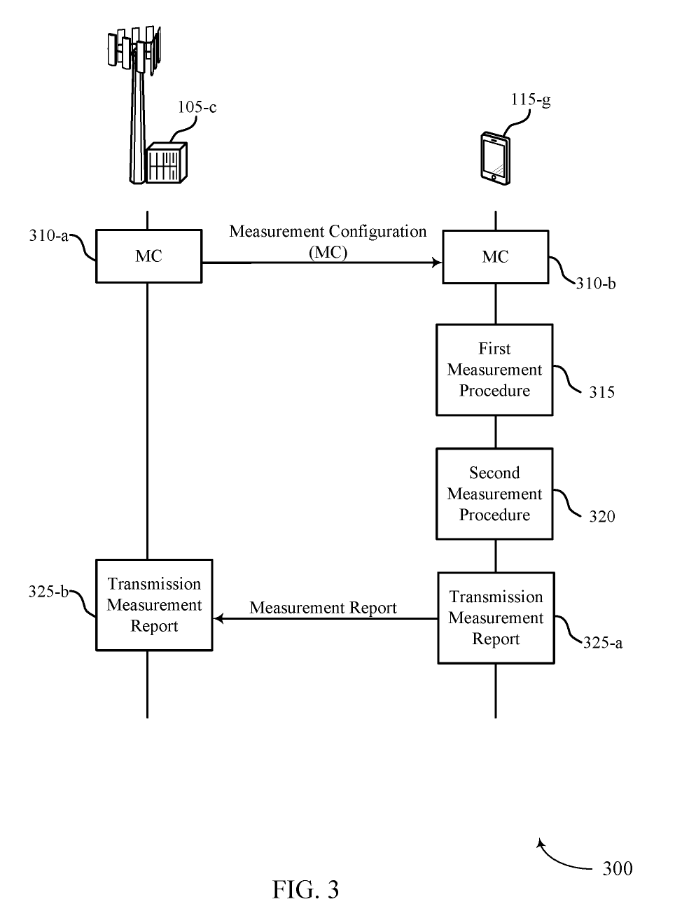

FIG. 3 illustrates an example of a process flow 300 for scheduling connected mode measurements for mobility operations in accordance with various aspects of the present disclosure. Process flow 300 may include base station 105-c and UE 115-g, which may be examples of the corresponding devices described with reference to FIG. 1-2.

At block 310-a, the base station 105-c may queue a measurement configuration for transmission to the UE 115-g during a downlink transmission. In some cases, the measurement configuration, which may include a list of measurement objects, for transmission to a UE during a downlink transmission. At block 310-b, the UE 115-g may receive the measurement configuration from the base station 105-c. In some cases, UE 115-g may receive the list of measurement objects from the base station 105-c. Additionally or alternatively, UE 115-g may receive a measurement configuration, which may include a list of measurement objects associated with measurements performed by the UE on signals received from cells in the wireless communication system. In some cases, a measurement object in the list of measurement objects may include a request for channel information between a UE and a base station and/or between a UE and other UEs within a geographical coverage area associated with the same and/or different base station.

At block 315, UE 115-g may perform a first measurement procedure on a first measurement object from the list. Additionally or alternatively, UE 115-g may perform a first measurement procedure comprising measuring a signal in the wireless communication system to detect one or more candidate cells associated with a first measurement object. In some cases, the first measurement procedure is performed a predetermined number of times. For example, UE 115-g may measure a quality of a communication link between the base station 105-c and/or any other base station within a predetermined geographical coverage area. In other cases, the first measurement procedure may direct the UE 115-g to measure a quality between the UE 115-g and other potential links, including other channels (e.g., frequencies) within a serving cell, other cells, and/or other radio access technologies (RATs). In some cases, UE 115-g may exclude the first measurement object from the list of measurement objects when the number of times that the first measurement procedure is performed exceeds a threshold. In some cases, UE 115-g excludes the first measurement object from the list for a predetermined duration (e.g., milliseconds, microseconds, seconds, minutes, hours, etc.). Additionally or alternatively, UE 115-g may suspend the first measurement object from the list of measurement objects when the predetermined number of times that the first measurement procedure is performed without detecting the one or more candidate cells associated with the first measurement object exceeds a threshold.

At block 320, UE 115-g may perform a second measurement procedure on a second measurement object from the list. Additionally or alternatively, UE 115-g may perform a second measurement procedure comprising measuring a signal in the wireless communication system on a second measurement object from the list to detect one or more candidate cells associated with the second measurement object. For example, the UE 115-g measure received signal quality (i.e., second measurement procedure) associated with a communication link, frequency, channel, etc., between the UE 115-g and a base station (e.g., base station 105-c). In some cases, UE 115-g may perform a second measurement procedure during the predetermined duration that the first measurement object is excluded from the list.

At block 325-a, UE 115-g may generate a measurement report. In some cases, the measurement report may include information associated with the measurement objects, for example, successful and/or unsuccessful measurements associated with a measurement object from the list of measurement objects. At block 325-b, the base station 105-c may receive the measurement report from UE 115-g.

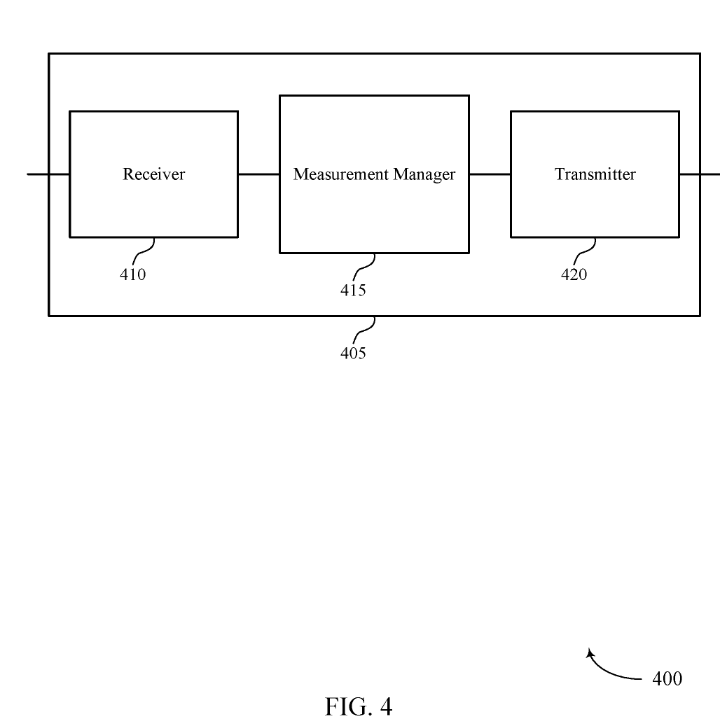

FIG. 4 shows a block diagram 400 of a wireless device 405 that supports scheduling connected mode measurements for mobility operations in accordance with various aspects of the present disclosure. Wireless device 405 may be an example of aspects of a UE 115 as described with reference to FIG. 1. Wireless device 405 may include receiver 410, measurement manager 415, and transmitter 420. Wireless device 405 may also include a processor. Each of these components may be in communication with one another (e.g., via one or more buses).

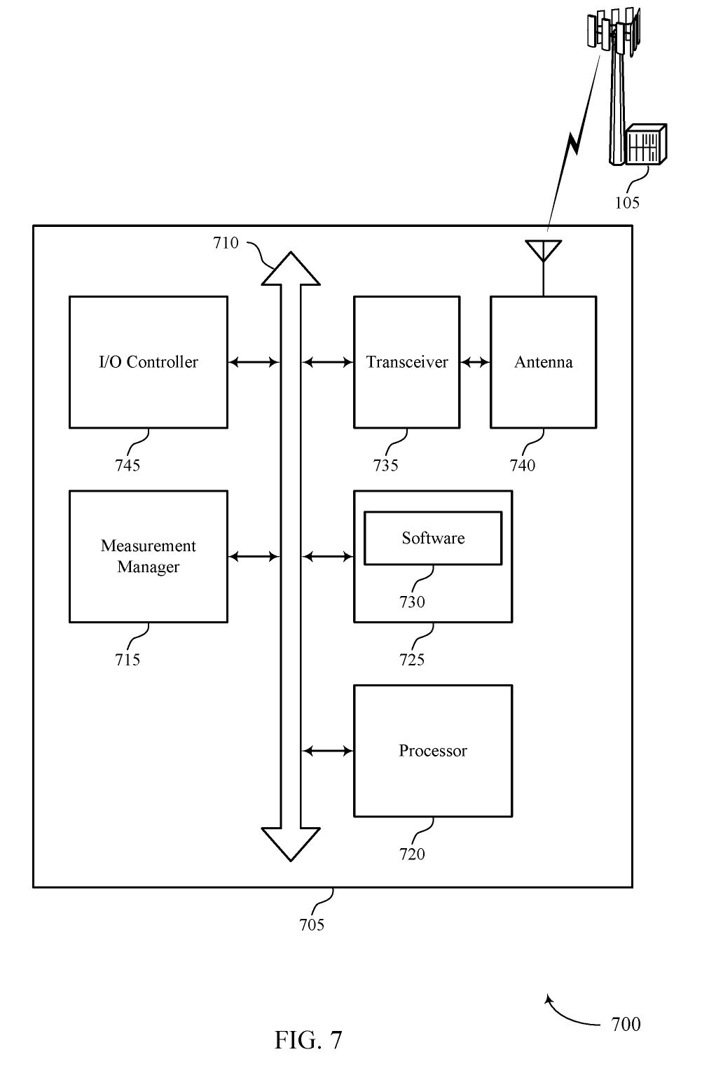

Receiver 410 may receive information such as packets, user data, or control information associated with various information channels (e.g., control channels, data channels, and information related to scheduling connected mode measurements for mobility operations, etc.). Information may be passed on to other components of the device. In some cases, the receiver 410 may receive a list of measurement objects from a base station. A measurement object may include a request for channel information between a UE and a base station, and/or between a UE and other UEs within a geographical coverage area of the same and/or different base station. In some cases, the channel information may include, received signal strength indicator (RSSI), received signal received power (RSPR), received signal received quality (RSRQ), a channel quality indicator (CQI), or a combination thereof. The receiver 410 may be an example of aspects of the transceiver 735 described with reference to FIG. 7. Receiver 410 may receive a list of measurement objects from a base station.

Measurement manager 415 may be an example of aspects of the measurement manager 715 described with reference to FIG. 7. Measurement manager 415 may perform a first measurement procedure on a first measurement object from the list. In some cases, the first measurement procedure is performed a number of times. The measurement manager 415 may exclude the first measurement object from the list of measurement objects when the number of times that the first measurement procedure is unsuccessfully performed exceeds a threshold. In some cases, a threshold may be associated with a number of times the measurement procedure is performed on the measurement object. In other cases, the threshold may be associated with a number of time times the measurement procedure is performed on the measurement object within a predetermined duration. For example, a measurement object may be excluded from the list by the measurement manager 415, if the measurement of the measurement object is unsuccessful a number of times (e.g., twice, or thrice). In further cases, the measurement manager 415 may exclude a measurement object from the list if the measurement of the measurement object is unsuccessful twice during a predetermined duration (e.g., seconds, minutes, etc.). In some cases, the measurement manager 415 may perform a second measurement procedure on a second measurement object from the list, and transmit a measurement report to the base station. The report may be based on a measurement successfully obtained from the second measurement procedure.

Transmitter 420 may transmit signals generated by other components of the device. In some cases, the transmitter 420 in communication with the measurement manager 415 may transmit the measurement report to a base station (e.g., base station 105). In some examples, the transmitter 420 may be collocated with a receiver 410 in a transceiver module. For example, the transmitter 420 may be an example of aspects of the transceiver 735 described with reference to FIG. 7. The transmitter 420 may include a single antenna, or it may include a set of antennas.

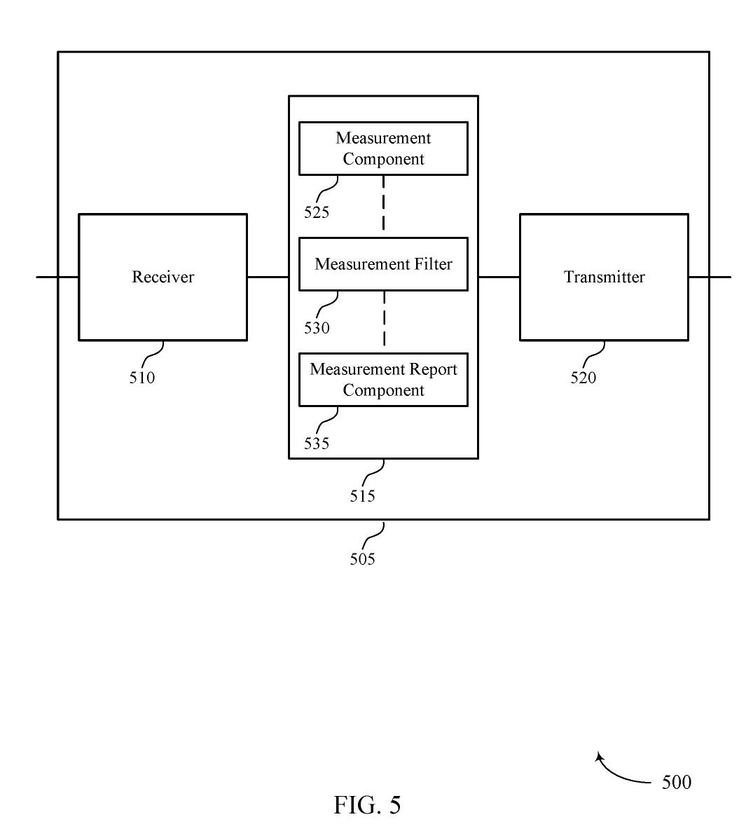

FIG. 5 shows a block diagram 500 of a wireless device 505 that supports scheduling connected mode measurements for mobility operations in accordance with various aspects of the present disclosure. Wireless device 505 may be an example of aspects of a wireless device 405 or a UE 115 as described with reference to FIGS. 1 and 4. Wireless device 505 may include receiver 510, measurement manager 515, and transmitter 520. Wireless device 505 may also include a processor. Each of these components may be in communication with one another (e.g., via one or more buses).

Receiver 510 may receive information such as packets, user data, or control information associated with various information channels (e.g., control channels, data channels, and information related to scheduling connected mode measurements for mobility operations, etc.). Information may be passed on to other components of the device. The receiver 510 may be an example of aspects of the transceiver 735 described with reference to FIG. 7.

Measurement manager 515 may be an example of aspects of the measurement manager 715 described with reference to FIG. 7. Measurement manager 515 may also include measurement component 525, measurement filter 530, and measurement report component 535. Measurement component 525 may perform a first measurement procedure on a first measurement object from the list. For example, measurement component 525 may measure a quality of a communication link between the wireless device (i.e., UE) and a serving cell (e.g., serving base station). In other cases, the first measurement procedure may direct the wireless device to measure a quality between the wireless device and other potential links, including other channels (e.g., frequencies) within the serving cell, other cells, and/or other radio access technologies (RATs). In some cases, the first measurement procedure may be performed a number of times, or during a predetermined duration, or a combination thereof.

In further cases, the measurement component 525 may perform a second measurement procedure on a second measurement object from the list. For example, the measurement component 525 may measure received signal quality (i.e., second measurement procedure) associated with a communication link, frequency, channel, etc., between the wireless device and a base station (e.g., base station 105). In some cases, the measurement component 525 may perform the first measurement procedure on the first measurement object an additional number of times after a predetermined duration. In other cases, the measurement component 525 may perform a second measurement procedure during the predetermined duration. In further cases, the measurement objects may include, but is not limited to, one or more communication channels associated with a serving cell, a neighbor cell, a frequency, a RAT, or any combination thereof.

Measurement filter 530 may exclude a measurement object from a list of measurement objects based on a number of times that a measurement procedure of a measurement object is unsuccessfully performed exceeds a threshold. In some cases, the measurement filter 530 may exclude a first measurement object from a list of measurement objects when the number of times that the first measurement procedure is unsuccessfully performed exceeds a threshold. In some cases, excluding the first measurement object from the list may include, but is not limited to, excluding the first measurement object from the list for a predetermined duration (e.g., seconds, minutes, etc.). Additionally or alternatively, excluding the first measurement object from the list may include, but is not limited to, suspending measurements of the one or more candidate cells associated with the first measurement object for a predetermined duration. In other cases, the threshold may be associated with a predetermined number of repetitions or a time duration, or both. In other cases, the first measurement object may be excluded or suspended from the list of measurement object for a consecutive number of measurement procedures. For example, the first measurement object may be excluded suspended from the list of measurement objects for two consecutive measurement procedures (e.g., second measurement object, third measurement object).

Measurement report component 535 may transmit a measurement report to the base station. In some cases, the report may be based on a measurement successfully obtained from the second measurement procedure. In some cases, the measurement report may include information associated with measurement results of the measurement objects in the measurement object list. For example, the information may include, but is not limited to, measured channel and/or frequency information such as, CSI, RSSI, RSPR, RSRQ, a CQI, or a combination thereof.

Transmitter 520 may transmit signals generated by other components of the device. In some examples, the transmitter 520 may be collocated with a receiver 510 in a transceiver module. For example, the transmitter 520 may be an example of aspects of the transceiver 735 described with reference to FIG. 7. The transmitter 520 may include a single antenna, or it may include a set of antennas.

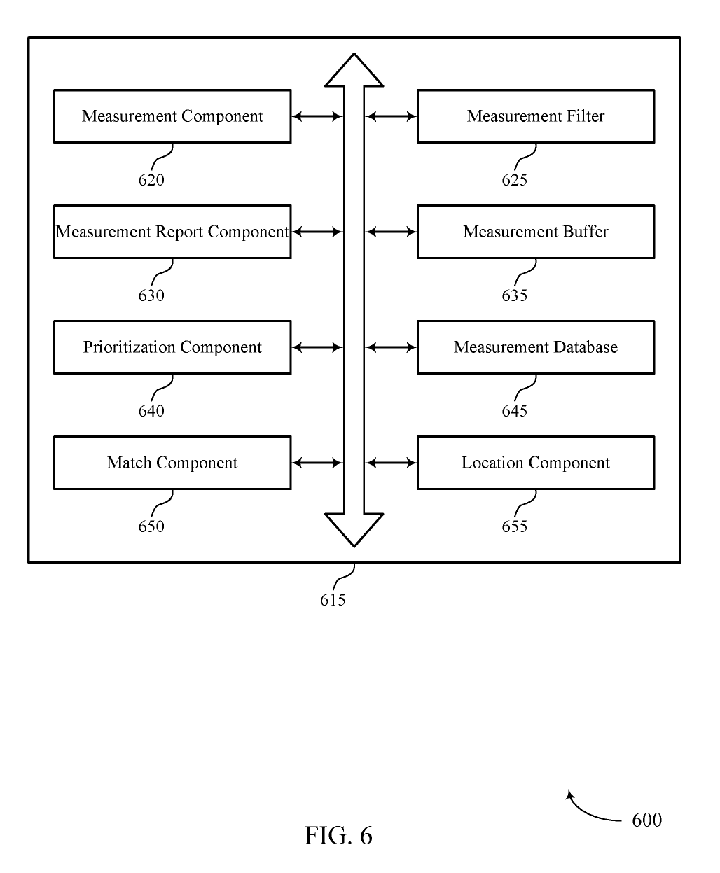

FIG. 6 shows a block diagram 600 of a measurement manager 615 that supports scheduling connected mode measurements for mobility operations in accordance with various aspects of the present disclosure. The measurement manager 615 may be an example of aspects of a measurement manager 415, a measurement manager 515, or a measurement manager 715 described with reference to FIGS. 4, 5, and 7. The measurement manager 615 may include measurement component 620, measurement filter 625, measurement report component 630, measurement buffer 635, prioritization component 640, measurement database 645, match component 650, and location component 655. Each of these modules may communicate, directly or indirectly, with one another (e.g., via one or more buses).

Measurement component 620 may perform a first measurement procedure on a first measurement object from the list. For example, measurement component 525 may measure a quality of a communication link between the wireless device (i.e., UE) and a serving cell (e.g., serving base station). In other cases, the first measurement procedure may direct the wireless device to measure a quality between the wireless device and other potential links, including other channels (e.g., frequencies) within the serving cell, other cells, and/or other RATs. In some cases, the first measurement procedure may be performed a number of times, or during a predetermined duration, or a combination thereof.

In further cases, the measurement component 525 may perform a second measurement procedure on a second measurement object from the list. For example, the measurement component 525 may measure received signal quality (i.e., second measurement procedure) associated with a communication link, frequency, channel, etc., between the wireless device and a base station (e.g., base station 105). In some cases, the measurement component 525 may perform the first measurement procedure on the first measurement object an additional number of times after a predetermined duration. In other cases, the measurement component 525 may perform a second measurement procedure during the predetermined duration. In further cases, the measurement objects may include, but is not limited to, one or more communication channels associated with a serving cell, a neighbor cell, a frequency, a RAT, or any combination thereof.

Measurement filter 625 may exclude a measurement object from a list of measurement objects based on a number of times that a measurement procedure of a measurement object is unsuccessfully performed exceeds a threshold. In some cases, the measurement filter 530 may exclude a first measurement object from a list of measurement objects when the number of times that the first measurement procedure is unsuccessfully performed exceeds a threshold. In some cases, excluding the first measurement object from the list may include, but is not limited to, excluding the first measurement object from the list for a predetermined duration (e.g., seconds, minutes, etc.). In some cases, excluding the first measurement object from the list may include, but is not limited to, suspending measurements of the one or more candidate cells associated with the first measurement object for a predetermined duration.

In other cases, the threshold may be associated with a predetermined number of repetitions or a time duration, or both. In other cases, the first measurement object may be excluded from the list of measurement object for a consecutive number of measurement procedures. For example, the first measurement object may be excluded from the list of measurement objects for two consecutive measurement procedures (e.g., second measurement object, third measurement object).

Measurement buffer 635, in some cases, may store indicators (e.g., successful/unsuccessful) associated with each measurement object previously and/or currently being measured. In some cases, the measurement buffer 635 may store an indication that a second measurement object was successfully measured based on obtaining a measurement from a second measurement procedure. In some cases, the measurement buffer 635 may store an indication that the one or more candidate cells associated with the second measurement object was measured based at least in part on obtaining the measurement from the second measurement procedure.

In some cases, prioritization component 640 may prioritize the second measurement object over at least one other measurement object from the list of measurement objects based on the indication and prioritize the at least one measurement object from the list of previously measured measurement objects over other measurement objects for a measurement procedure. For example, the UE may receive a list of measurement objects from a network device and prioritize the list by analyzing the measurement objects in the list to the previously measured measurement objects using the indication associated with each measurement object. In some cases, the analysis may indicate that at least one measurement object from the list of previously measured measurement objects is common to a measurement object in the list of measurement objects received from the base station.

In some cases, the prioritization component 640 may communicate with the measurement database 645 to retrieve a list of previously measured measurement objects from a database. After retrieving the list of previously measured measurement objects, the prioritization component 640 may communicate with the match component 650 to determine that at least one measurement object from the list of previously measured measurement objects is common to a measurement object in the list of measurement objects received from the base station. In some cases, as a result, the prioritization component 640 may prioritize the at least one measurement object from the list of previously measured measurement objects over other measurement objects for a measurement procedure.

Location component 655, in some cases, may determine a location of a UE that received the list of measurement objects from the base station. In some cases, the location component 655 may identify the at least one measurement object from the list of previously measured measurement objects based on the location of the UE. In some cases, the at least one measurement object may be prioritized based on the location of the UE. In other cases, the location of the UE may be determined based on GPS coordinates of the UE. In some cases, the at least one measurement object from the list of previously measured measurement objects is identified based on GPS coordinates of the UE when the at least one measurement object was previously measured.

FIG. 7 shows a diagram of a system 700 including a device 705 that supports scheduling connected mode measurements for mobility operations in accordance with various aspects of the present disclosure. Device 705 may be an example of or include the components of wireless device 405, wireless device 505, or a UE 115 as described above, e.g., with reference to FIGS. 1, 4 and 5. Device 705 may include components for bidirectional voice and data communications including components for transmitting and receiving communications, including measurement manager 715, processor 720, memory 725, software 730, transceiver 735, antenna 740, and I/O controller 745.

Processor 720 may include an intelligent hardware device, (e.g., a general-purpose processor, a digital signal processor (DSP), a central processing unit (CPU), a microcontroller, an application specific integrated circuit (ASIC), a field-programmable gate array (FPGA), a programmable logic device, a discrete gate or transistor logic component, a discrete hardware component, or any combination thereof). In some cases, processor 720 may be configured to operate a memory array using a memory controller. In other cases, a memory controller may be integrated into processor 720. Processor 720 may be configured to execute computer-readable instructions stored in a memory to perform various functions (e.g., functions or tasks supporting scheduling connected mode measurements for mobility operations) 720.

Memory 725 may include random access memory (RAM) and read only memory (ROM). The memory 725 may store computer-readable, computer-executable software 730 including instructions that, when executed, cause the processor to perform various functions described herein. In some cases, the memory 725 may contain, among other things, a Basic Input-Output system (BIOS) which may control basic hardware and/or software operation such as the interaction with peripheral components or devices.

Software 730 may include code to implement aspects of the present disclosure, including code to support scheduling connected mode measurements for mobility operations. Software 730 may be stored in a non-transitory computer-readable medium such as system memory or other memory. In some cases, the software 730 may not be directly executable by the processor but may cause a computer (e.g., when compiled and executed) to perform functions described herein.

Transceiver 735 may communicate bi-directionally, via one or more antennas, wired, or wireless links as described above. For example, the transceiver 735 may represent a wireless transceiver and may communicate bi-directionally with another wireless transceiver. The transceiver 735 may also include a modem to modulate the packets and provide the modulated packets to the antennas for transmission, and to demodulate packets received from the antennas.

In some cases, the wireless device may include a single antenna 740. However, in some cases the device may have more than one antenna 740, which may be capable of concurrently transmitting or receiving multiple wireless transmissions.

I/O controller 745 may manage input and output signals for device 705. I/O controller 745 may also manage peripherals not integrated into device 705. In some cases, I/O controller 745 may represent a physical connection or port to an external peripheral. In some cases, I/O controller 745 may utilize an operating system such as iOS®, ANDROID®, MS-DOS®, MS-WINDOWS®, OS/2®, UNIX®, LINUX®, or another known operating system.

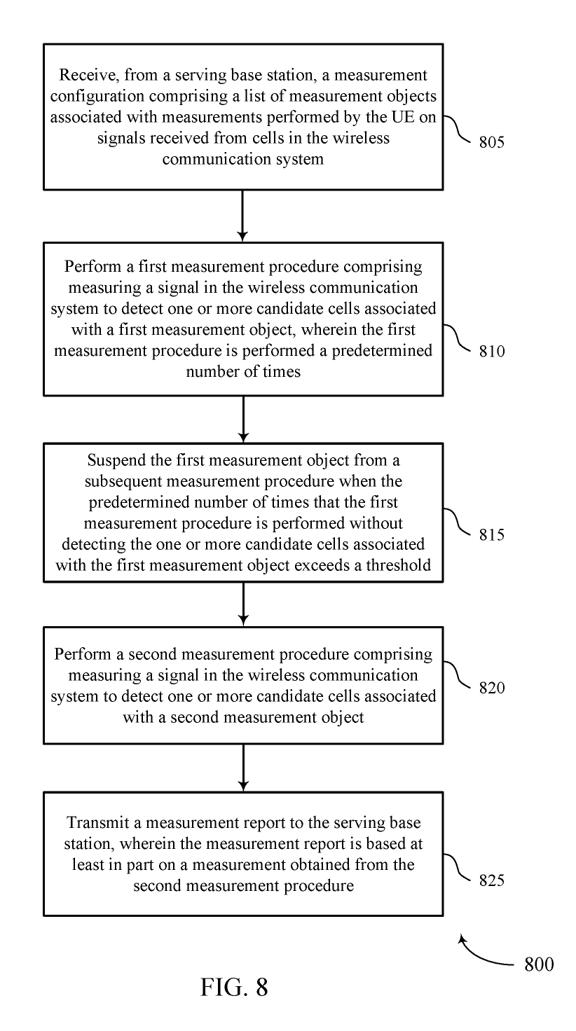

FIG. 8 shows a flowchart illustrating a method 800 for scheduling connected mode measurements for mobility operations in accordance with various aspects of the present disclosure. The operations of method 800 may be implemented by a UE 115 or its components as described herein. For example, the operations of method 800 may be performed by a measurement manager as described with reference to FIGS. 4 through 7. In some examples, a UE 115 may execute a set of codes to control the functional elements of the device to perform the functions described below. Additionally or alternatively, the UE 115 may perform aspects the functions described below using special-purpose hardware.

At block 805 the UE 115 may receive, from a serving base station, a measurement configuration comprising a list of measurement objects associated with measurements performed by a UE on signals received from cells in a wireless communication system. The operations of block 805 may be performed according to the methods described with reference to FIGS. 1 through 3. In certain examples, aspects of the operations of block 805 may be performed by a receiver as described with reference to FIGS. 4 through 7.

At block 810 the UE 115 may perform a first measurement procedure comprising measuring a signal in the wireless communication system to detect one or more candidate cells associated with the first measurement object. In some cases, the first measurement procedure may be performed a predetermined number of times. The operations of block 810 may be performed according to the methods described with reference to FIGS. 1 through 3. In certain examples, aspects of the operations of block 810 may be performed by a measurement component as described with reference to FIGS. 4 through 7.

At block 815 the UE 115 may suspend the first measurement object from the list of measurement objects when the predetermined number of times that the first measurement procedure is performed without detecting the one or more candidate cells associated with the first measurement object exceeds a threshold. The operations of block 815 may be performed according to the methods described with reference to FIGS. 1 through 3. In certain examples, aspects of the operations of block 815 may be performed by a measurement filter as described with reference to FIGS. 4 through 7.

At block 820 the UE 115 may perform a second measurement procedure comprising measuring a signal in the wireless communication system on a second measurement object from the list to detect one or more candidate cells associated with the second measurement object. The operations of block 820 may be performed according to the methods described with reference to FIGS. 1 through 3. In certain examples, aspects of the operations of block 820 may be performed by a measurement component as described with reference to FIGS. 4 through 7.

At block 825 the UE 115 may transmit a measurement report to the serving base station. In some cases, the measurement report is based at least in part on a measurement obtained from the second measurement procedure. The operations of block 825 may be performed according to the methods described with reference to FIGS. 1 through 3. In certain examples, aspects of the operations of block 825 may be performed by a measurement report component as described with reference to FIGS. 4 through 7.

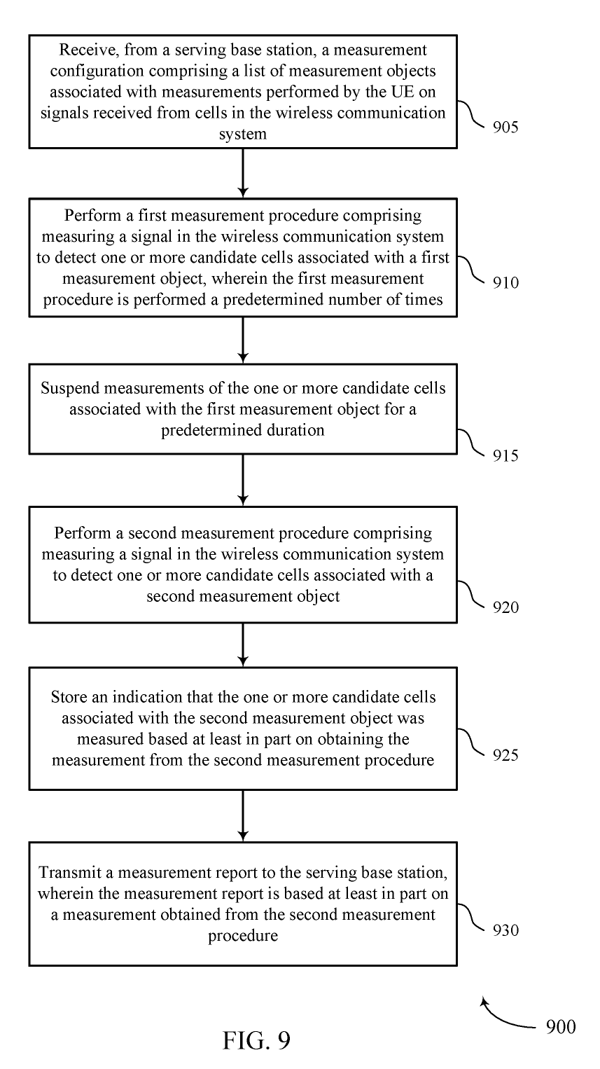

FIG. 9 shows a flowchart illustrating a method 900 for scheduling connected mode measurements for mobility operations in accordance with various aspects of the present disclosure. The operations of method 900 may be implemented by a UE 115 or its components as described herein. For example, the operations of method 900 may be performed by a measurement manager as described with reference to FIGS. 4 through 7. In some examples, a UE 115 may execute a set of codes to control the functional elements of the device to perform the functions described below. Additionally or alternatively, the UE 115 may perform aspects the functions described below using special-purpose hardware.

At block 905 the UE 115 may receive, from a serving base station, a measurement configuration comprising a list of measurement objects associated with measurements performed by a UE on signals received from cells in a wireless communication system. The operations of block 905 may be performed according to the methods described with reference to FIGS. 1 through 3. In certain examples, aspects of the operations of block 905 may be performed by a receiver as described with reference to FIGS. 4 through 7.

At block 910 the UE 115 may perform a first measurement procedure comprising measuring a signal in the wireless communication system to detect one or more candidate cells associated with the first measurement object. In some cases, the first measurement procedure is performed a predetermined number of times. The operations of block 910 may be performed according to the methods described with reference to FIGS. 1 through 3. In certain examples, aspects of the operations of block 910 may be performed by a measurement component as described with reference to FIGS. 4 through 7.

At block 915 the UE 115 may suspend measurements of the one or more candidate cells associated with the first measurement object for a predetermined duration.

The operations of block 915 may be performed according to the methods described with reference to FIGS. 1 through 3. In certain examples, aspects of the operations of block 915 may be performed by a measurement filter as described with reference to FIGS. 4 through 7.

At block 920 the UE 115 may perform a second measurement procedure comprising measuring a signal in the wireless communication system on a second measurement object from the list to detect one or more candidate cells associated with the second measurement object. The operations of block 920 may be performed according to the methods described with reference to FIGS. 1 through 3. In certain examples, aspects of the operations of block 920 may be performed by a measurement component as described with reference to FIGS. 4 through 7.

At block 925 the UE 115 may store an indication that the one or more candidate cells associated with the second measurement object was measured based at least in part on obtaining the measurement from the second measurement procedure. The operations of block 925 may be performed according to the methods described with reference to FIGS. 1 through 3. In certain examples, aspects of the operations of block 925 may be performed by a measurement buffer as described with reference to FIGS. 4 through 7.

At block 930 the UE 115 may transmit a measurement report to the serving base station, wherein the measurement report is based at least in part on a measurement obtained from the second measurement procedure. The operations of block 930 may be performed according to the methods described with reference to FIGS. 1 through 3. In certain examples, aspects of the operations of block 930 may be performed by a measurement report component as described with reference to FIGS. 4 through 7.

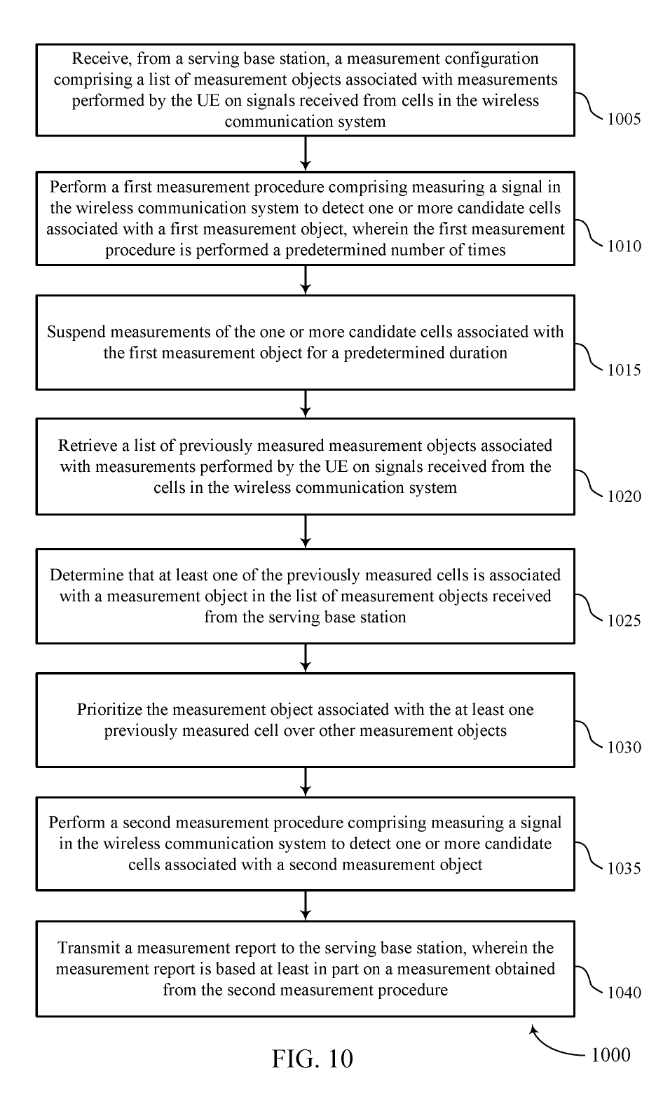

FIG. 10 shows a flowchart illustrating a method 1000 for scheduling connected mode measurements for mobility operations in accordance with various aspects of the present disclosure. The operations of method 1000 may be implemented by a UE 115 or its components as described herein. For example, the operations of method 1000 may be performed by a measurement manager as described with reference to FIGS. 4 through 7. In some examples, a UE 115 may execute a set of codes to control the functional elements of the device to perform the functions described below. Additionally or alternatively, the UE 115 may perform aspects the functions described below using special-purpose hardware.

At block 1005 the UE 115 may receive, from a serving base station, a measurement configuration comprising a list of measurement objects associated with measurements performed by a UE on signals received from cells in a wireless communication system. The operations of block 1005 may be performed according to the methods described with reference to FIGS. 1 through 3. In certain examples, aspects of the operations of block 1005 may be performed by a receiver as described with reference to FIGS. 4 through 7.

At block 1010 the UE 115 may perform a first measurement procedure comprising measuring a signal in the wireless communication system to detect one or more candidate cells associated with the first measurement object. In some cases, the first measurement procedure is performed a predetermined number of times. The operations of block 1010 may be performed according to the methods described with reference to FIGS. 1 through 3. In certain examples, aspects of the operations of block 1010 may be performed by a measurement component as described with reference to FIGS. 4 through 7.

At block 1015 the UE 115 may suspend measurements of the one or more candidate cells associated with the first measurement object for a predetermined duration. The operations of block 1015 may be performed according to the methods described with reference to FIGS. 1 through 3. In certain examples, aspects of the operations of block 1015 may be performed by a measurement filter as described with reference to FIGS. 4 through 7.

At block 1020 the UE 115 may retrieve a list of previously measured measurement objects associated with measurements performed by the UE on signals received from the cells in the wireless communication system from a database. The operations of block 1020 may be performed according to the methods described with reference to FIGS. 1 through 3. In certain examples, aspects of the operations of block 1020 may be performed by a measurement database as described with reference to FIGS. 4 through 7.

At block 1025 the UE 115 may determine that at least one of the previously measured cells is associated with a measurement object in the list of measurement objects received from the serving base station. The operations of block 1025 may be performed according to the methods described with reference to FIGS. 1 through 3. In certain examples, aspects of the operations of block 1025 may be performed by a match component as described with reference to FIGS. 4 through 7.

At block 1030 the UE 115 may prioritize the measurement object associated with the at least one previously measured cell over other measurement objects for a measurement procedure. The operations of block 1030 may be performed according to the methods described with reference to FIGS. 1 through 3. In certain examples, aspects of the operations of block 1030 may be performed by a prioritization component as described with reference to FIGS. 4 through 7.

At block 1035 the UE 115 may perform a second measurement procedure comprising measuring a signal in the wireless communication system on a second measurement object from the list to detect one or more candidate cells associated with the second measurement object. The operations of block 1035 may be performed according to the methods described with reference to FIGS. 1 through 3. In certain examples, aspects of the operations of block 1035 may be performed by a measurement component as described with reference to FIGS. 4 through 7.

At block 1040 the UE 115 may transmit a measurement report to the serving base station, wherein the measurement report is based at least in part on a measurement obtained from the second measurement procedure. The operations of block 1040 may be performed according to the methods described with reference to FIGS. 1 through 3. In certain examples, aspects of the operations of block 1040 may be performed by a measurement report component as described with reference to FIGS. 4 through 7.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM).

An orthogonal frequency division multiple access (OFDMA) system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications system (UMTS). 3GPP Long Term Evolution (LTE) and LTE-Advanced (LTE-A) are new releases of Universal Mobile Telecommunications System (UMTS) that use E-UTRA. UTRA, E-UTRA, UMTS, LTE, LTE-A, and Global System for Mobile communications (GSM) are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. While aspects an LTE system may be described for purposes of example, and LTE terminology may be used in much of the description, the techniques described herein are applicable beyond LTE applications.

In LTE/LTE-A networks, including such networks described herein, the term evolved node B (eNB) may be generally used to describe the base stations. The wireless communications system or systems described herein may include a heterogeneous LTE/LTE-A network in which different types of evolved node B (eNBs) provide coverage for various geographical regions. For example, each eNB or base station may provide communication coverage for a macro cell, a small cell, or other types of cell. The term “cell” may be used to describe a base station, a carrier or component carrier associated with a base station, or a coverage area (e.g., sector, etc.) of a carrier or base station, depending on context.

Base stations may include or may be referred to by those skilled in the art as a base transceiver station, a radio base station, an access point, a radio transceiver, a NodeB, eNodeB (eNB), Home NodeB, a Home eNodeB, or some other suitable terminology. The geographic coverage area for a base station may be divided into sectors making up only a portion of the coverage area. The wireless communications system or systems described herein may include base stations of different types (e.g., macro or small cell base stations). The UEs described herein may be able to communicate with various types of base stations and network equipment including macro eNBs, small cell eNBs, relay base stations, and the like. There may be overlapping geographic coverage areas for different technologies.

A macro cell generally covers a relatively large geographic area (e.g., several kilometers in radius) and may allow unrestricted access by UEs with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers). A UE may be able to communicate with various types of base stations and network equipment including macro eNBs, small cell eNBs, relay base stations, and the like.

The wireless communications system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communication system 100 and 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method performed by a user equipment (UE) in a wireless communication system, comprising:
receiving, from a serving base station, a measurement configuration comprising a list of measurement objects associated with measurements performed by the UE on signals received from cells in the wireless communication system;
performing a first measurement procedure comprising measuring a signal in the wireless communication system to detect one or more candidate cells associated with a first measurement object, wherein the first measurement procedure is performed a predetermined number of times;
suspending the first measurement object from a subsequent measurement procedure when the predetermined number of times that the first measurement procedure is performed without detecting the one or more candidate cells associated with the first measurement object exceeds a threshold;
performing a second measurement procedure comprising measuring a signal in the wireless communication system to detect one or more candidate cells associated with a second measurement object; and
transmitting a measurement report to the serving base station, wherein the measurement report is based at least in part on a measurement obtained from the second measurement procedure.

2. The method of claim 1, wherein suspending the first measurement object comprises:
suspending measurements of the one or more candidate cells associated with the first measurement object for a predetermined duration.

3. The method of claim 2, further comprising:
performing the first measurement procedure on the first measurement object an additional number of times after the predetermined duration.

4. The method of claim 2, wherein the second measurement procedure is performed during the predetermined duration.

5. The method of claim 1, further comprising:
storing an indication that the one or more candidate cells associated with the second measurement object was measured based at least in part on obtaining the measurement from the second measurement procedure.

6. The method of claim 5, further comprising:
prioritizing the second measurement object for the subsequent measurement procedure over at least one other measurement object from the list of measurement objects based at least in part on the indication.

7. The method of claim 1, further comprising:
retrieving a list of previously measured measurement objects associated with measurements performed by the UE on signals received from the cells in the wireless communication system;
determining that at least one previously measured cell is associated with a measurement object in the list of measurement objects received from the serving base station; and
prioritizing the measurement object associated with the at least one previously measured cell over other measurement objects.

8. The method of claim 7, further comprising:
determining a location of the UE; and
identifying the at least one previously measured cell from the list of previously measured measurement objects based at least in part on the location of the UE, wherein the measurement object is prioritized based at least in part on an association with the at least one previously measured cell and the location of the UE.

9. The method of claim 8, wherein the location of the UE is determined based at least in part on global positioning system (GPS) coordinates of the UE.

10. The method of claim 8, wherein the at least one previously measured cell is identified based at least in part on global positioning system (GPS) coordinates of the UE when the at least one previously measured cell was measured.

11. The method of claim 1, wherein the threshold is associated with a predetermined number of repetitions or a time duration, or both.

12. The method of claim 1, wherein the measurement objects are associated with at least one of a serving cell, a neighbor cell, a frequency, a radio access technology (RAT), or any combination thereof.

13. An apparatus for wireless communication, comprising:
means for receiving, from a serving base station, a measurement configuration comprising a list of measurement objects associated with measurements performed by a UE on signals received from cells in a wireless communication system;
means for performing a first measurement procedure comprising measuring a signal in the wireless communication system to detect one or more candidate cells associated with a first measurement object, wherein the first measurement procedure is performed a predetermined number of times;
means for suspending the first measurement object from a subsequent measurement procedure when the predetermined number of times that the first measurement procedure is performed without detecting the one or more candidate cells associated with the first measurement object exceeds a threshold;
means for performing a second measurement procedure comprising measuring a signal in the wireless communication system to detect one or more candidate cells associated with a second measurement object; and
means for transmitting a measurement report to the serving base station, wherein the measurement report is based at least in part on a measurement obtained from the second measurement procedure.

14. The apparatus of claim 13, wherein suspending the first measurement object comprises:
means for suspending measurements of the one or more candidate cells associated with the first measurement object for a predetermined duration.

15. The apparatus of claim 14, further comprising:
means for performing the first measurement procedure on the first measurement object an additional number of times after the predetermined duration.

16. The apparatus of claim 13, further comprising:
means for storing an indication that the one or more candidate cells associated with the second measurement object was measured based at least in part on obtaining the measurement from the second measurement procedure.

17. The apparatus of claim 16, further comprising:
means for prioritizing the second measurement object for the subsequent measurement procedure over at least one other measurement object from the list of measurement objects based at least in part on the indication.

18. A mobile device, comprising:
a processor;
memory in electronic communication with the processor; and
instructions stored in the memory and operable, when executed by the processor, to cause the mobile device to:
receive, from a serving base station, a measurement configuration comprising a list of measurement objects associated with measurements performed by the UE on signals received from cells in a wireless communication system;
perform a first measurement procedure comprising measuring a signal in the wireless communication system to detect one or more candidate cells associated with a first measurement object, wherein the first measurement procedure is performed a predetermined number of times;
suspend the first measurement object from a subsequent measurement procedure when the predetermined number of times that the first measurement procedure is performed without detecting the one or more candidate cells associated with the first measurement object exceeds a threshold;
perform a second measurement procedure comprising measuring a signal in the wireless communication system to detect one or more candidate cells associated with a second measurement object; and
transmit a measurement report to the serving base station, wherein the measurement report is based at least in part on a measurement obtained from the second measurement procedure.

19. The mobile device of claim 18, wherein the instructions are operable to cause the mobile device to:
suspend measurements of the one or more candidate cells associated with the first measurement object for a predetermined duration.

20. The mobile device of claim 19, wherein the instructions are operable to cause the mobile device to:
perform the first measurement procedure on the first measurement object an additional number of times after the predetermined duration.

21. The mobile device of claim 19, wherein the second measurement procedure is performed during the predetermined duration.

22. The mobile device of claim 18, wherein the instructions are operable to cause the mobile device to:
store an indication that the one or more candidate cells associated with the second measurement object was measured based at least in part on obtaining the measurement from the second measurement procedure.

23. The mobile device of claim 22, wherein the instructions are operable to cause the mobile device to:
prioritize the second measurement object for the subsequent measurement procedure over at least one other measurement object from the list of measurement objects based at least in part on the indication.

24. The mobile device of claim 18, wherein the instructions are operable to cause the mobile device to:
retrieve a list of previously measured measurement objects associated with measurements performed by the mobile device on signals received from the cells in the wireless communication system;
determine that at least one previously measured cell is associated with a measurement object in the list of measurement objects received from the serving base station; and
prioritize the measurement object associated with the at least one previously measured cell over other measurement objects.

25. The mobile device of claim 24, wherein the instructions are operable to cause the mobile device to:
determine a location of the mobile device; and
identify the at least one previously measured cell from the list of previously measured measurement objects based at least in part on the location of the mobile device, wherein the at least one previously measured cell is prioritized based at least in part on an association with the at least one previously measured cell and the location of the mobile device.

26. The mobile device of claim 25, wherein the location of the mobile device is determined based at least in part on global positioning system (GPS) coordinates of the mobile device.

27. The mobile device of claim 25, wherein the at least one previously measured cell is identified based at least in part on global positioning system (GPS) coordinates of the mobile device when the at least one previously measured cell was measured.

28. The mobile device of claim 18, wherein the threshold is associated with a predetermined number of repetitions or a time duration, or both.

29. The mobile device of claim 18, wherein the measurement objects are associated with at least one of a serving cell, a neighbor cell, a frequency, a radio access technology (RAT), or any combination thereof.

30. A non-transitory computer readable medium storing code for wireless communication, the code comprising instructions executable to:
receive, from a serving base station, a measurement configuration comprising a list of measurement objects associated with measurements performed by the UE on signals received from cells in a wireless communication system;
perform a first measurement procedure comprising measuring a signal in the wireless communication system to detect one or more candidate cells associated with a first measurement object, wherein the first measurement procedure is performed a predetermined number of times;
suspend the first measurement object from a subsequent measurement procedure when the predetermined number of times that the first measurement procedure is performed without detecting the one or more candidate cells associated with the first measurement object exceeds a threshold;
perform a second measurement procedure comprising measuring a signal in the wireless communication system to detect one or more candidate cells associated with a second measurement object; and
transmit a measurement report to the serving base station, wherein the measurement report is based at least in part on a measurement obtained from the second measurement procedure.
